(19) United States
(12) Patent Application Publication
(10) Pub. No.: US 2020/0143293 A1
(43) Pub. Date: May 7, 2020

(54) Machine Learning Based Capacity Management Automated System

(71) Applicant: Microsoft Technology Licensing, LLC, Redmond, WA (US)

(72) Inventor: Sorin IFTIMIE, Issaquah, WA (US)

(73) Assignee: Microsoft Technology Licensing, LLC, Redmond, WA (US)

(21) Appl. No.: 16/177,892

(22) Filed: Nov. 1, 2018

(51) Int. Cl. G06N 99/00

(52) U.S. Cl. CPC G06N 99/005; G06N 3/08

(57) ABSTRACT

Described herein is an automated capacity management system and method. Input information regarding current conditions of the computing system, and, user data requirements are received. Capacity is predicted based upon at least some of the received input information using a machine trained capacity model. Demand is predicted upon at least some of the received input using a machine trained demand model. Logic is applied to determine one or more mitigation actions to be taken with respect to the computing system in accordance with the predicted capacity and predicted demand. An action based upon the one or more determined mitigation actions is then performed.

### BACKGROUND

Large companies operate increasingly complex infrastructures to collect, store and analyze vast amounts of data. For example, a particular infrastructure can include a quantity of very large clusters (e.g., up to 50,000 nodes each) serving thousands of consumers (e.g., data scientists), running hundreds of thousands of jobs daily, and accessing billions of files.

Managing capacity associated with the infrastructure (e.g., resources and jobs) is a complicated process conventionally managed by human users based on an empiric evaluation of the infrastructure. Such management can often lead to wasted resources, user frustration, and/or violation of service level agreement(s).

### SUMMARY

Described herein is an automated capacity management system, comprising: a computer comprising a processor and a memory having computer-executable instructions stored thereupon which, when executed by the processor, cause the computer to: receive input information regarding current conditions of the computing system, and, user data requirements; predict capacity based upon at least some of the received input information using a machine trained capacity model; predict demand based upon at least some of the received input using a machine trained demand model; apply logic to determine one or more mitigation actions to be taken with respect to the computing system in accordance with the predicted capacity and predicted demand; and perform an action based upon the one or more determined mitigation actions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates an automated capacity management system.

FIG. 2 is a flow chart that illustrates a method of automatically managing capacity of a computing system.

FIGS. 3 and 4 are flow charts that illustrate another method of automatically managing capacity of a computing system.

FIG. 5 is a functional block diagram that illustrates an exemplary computing system.

### DETAILED DESCRIPTION

Various technologies pertaining to a machine learning based capacity management automated mitigation system and method are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding a machine learning based capacity management automated mitigation system and method. What follows are one or more exemplary systems and methods.

Aspects of the subject disclosure pertain to the technical problem of managing capacity of large data systems. The technical features associated with addressing this problem involve receiving input information regarding current conditions of the computing system, user data requirements, and/or anticipated future condition(s) of the computing system; using a machine trained capacity model to predict capacity based upon at least some of the received input information; use a machine trained demand model to predict demand based upon at least some of the received input; applying logic to determine one or more mitigation actions to be taken with respect to the computing system in accordance with the predicted capacity and predicted demand; and, performing an action based upon the determined one or mitigation action(s). Accordingly, aspects of these technical features exhibit technical effects of more efficiently and effectively managing and/or utilizing computer resources of large data systems, for example, reducing wasted computer resources and/or computation time.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, and/or sub-systems) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

Efficient and effective capacity management of a computing cluster system comprising tens of thousands of individual compute nodes based upon even a single variable/parameter can be beyond the capabilities of even the most qualified human operations manager or team of human operations managers. Manually managing such a computing cluster system taking into account a plurality of variables/parameters thus is not efficient or effective.

Described herein is a machine learning based capacity management automated mitigation system and method which can automatically solve the capacity management problem for a single and/or a global multi-region cloud provider. The system and method can make use of data and machine-learned models to automatically manage capacity of a computing cluster system resulting in, for example, an increased return on investment, increased up-time, and/or increased customer satisfaction.

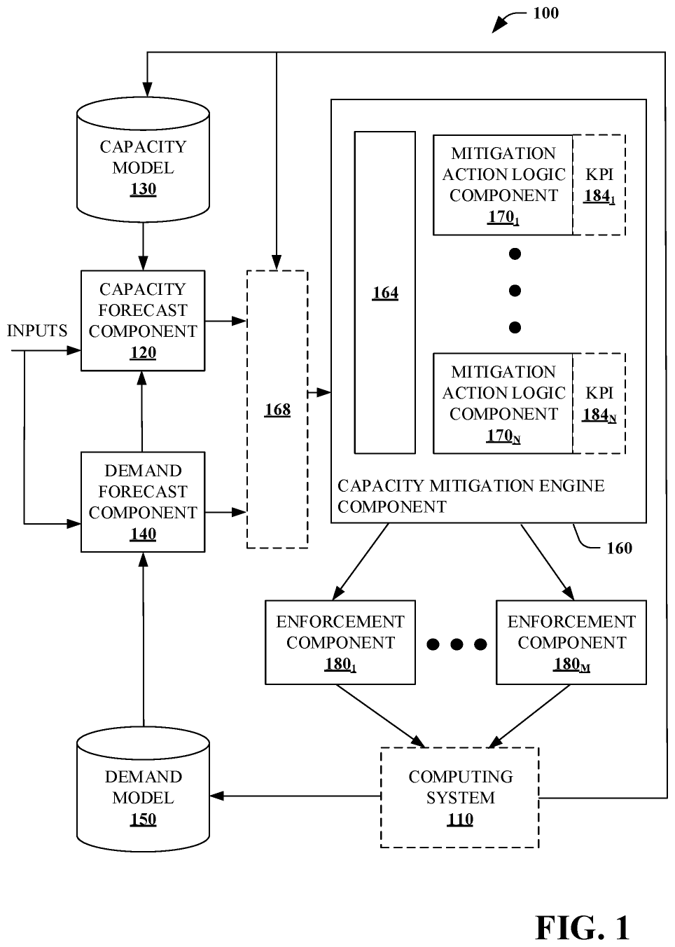

Referring to FIG. 1, an automated capacity management system 100 100 is illustrated. The system 100 utilizes information about current, forecasted, and/or past condition(s) regarding a computing cluster system 110, and, machine learning based models to determine mitigation action(s) to be employed in order to efficiently and effectively automatically manage capacity of the computing cluster system. The system 100 is thus a dynamic system that can generate a forecast and act on the computing cluster system 110 in accordance with the forecast. In some embodiments, the system 100 can be self-tuning by adaptively updating models and/or logic based upon actual results produced in response to action(s) taken in response to the forecast. By dynamically predicting demand in view of capacity, the system 100 can proactively ensure that adequate resources are available in order to meet customer needs/requirements without having an excessive amount of unused resources (e.g., idle computing resources).

In some embodiments, the system 100 can utilize a demand forecast and an available capacity forecast to decide what action(s) should be taken on the computing system to alleviate a lack of capacity and/or to release restrictions already in place. The system 100 can utilize discrete enforcement systems for various mitigation actions (MAs) imposed on the computing system. In some embodiments, the computing cluster system 110 is a component of the system 100. In some other embodiments, the computing cluster system 110 is not a component of the system 100.

Inputs from components, subsystems, and/or systems that affect platform behavior are received. The inputs can be in the form of data feeds that provide normalized and/or aggregated data for use by the system 100. In some embodiments, the inputs can provide information regarding user(s) (e.g., contractual requirements set forth in a service level agreement), the computing cluster system 110 (e.g., past, current, and/or anticipated future condition(s)), and/or an operator/owner of the computing cluster system 110 (e.g., geographical, regional, and/or legal requirement(s)). For example, the inputs can include information regarding region/SKU/segment reference data, hardware to virtual machine (VM) family mapping, utilization, available capacity, existing offer restriction(s) (OR), existing quota threshold(s) (QT), cluster fragmentation, hardware out for repair (OFR), and/or, build out request(s). In some embodiments, the data feeds are produced periodically (e.g., hourly, daily) in order to allow the system 100 to dynamically react to changes that affect capacity and/or demand. When the system 100 accurately matches predicted demand with predicted capacity, the system 100 has converged.

The system 100 includes a capacity forecast component 120 that predicts capacity of the computing cluster 110 using a capacity model 130 in accordance with current, forecasted, and/or past condition(s) as provided by the inputs. Prior to use within the system 100, the capacity model 130 can be trained using a machine learning process that utilizes various features present in the inputs with the capacity model 130 representing an association among the features. In some embodiments, the capacity model 130 is trained using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, Artificial Neural Network (ANN) and/or a Gradient Boost & Adaboost algorithm.

Training can be performed in a supervised, unsupervised and/or semi-supervised manner. Training can determine which of the inputs are utilized by the capacity model 130 and how those inputs are utilized to predict capacity. Information regarding the capacity predicted using the capacity model 130 can be compared with the actual capacity (e.g., observed) and the capacity model 130 can then be adjusted accordingly. Once trained the capacity model 130 can be utilized by the system 100 to predict capacity of the computing cluster 110 given a particular set of inputs.

The system 100 further includes a demand forecast component 140 that predicts demands of the computing cluster 110 using a demand model 150 in accordance with current, forecasted, and/or past condition(s) as provided by the inputs. Prior to use within the system 100, the demand model 150 can be trained using a machine learning process that takes utilizes various features present in the inputs with the demand model 150 representing an association among the features. In some embodiments, the demand model 150 is trained using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, Artificial Neural Network (ANN) and/or a Gradient Boost & Adaboost algorithm.

Training can be performed in a supervised, unsupervised and/or semi-supervised manner. Training can determine which of the inputs are utilized by the demand model 150 and how those inputs are utilized to predict capacity. Information regarding the demand predicted using the demand model 150 can be compared with the actual demand (e.g., observed) and the demand model 150 can be adjusted accordingly. Once trained the demand model 150 can be utilized by the system 100 to predict demand of the computing cluster 110 for a particular set of inputs. In some embodiments, demand is predicted on a short term and unrestricted basis.

The system 100 includes a capacity mitigation engine component 160 having a business logic policy component 164 that determines mitigation action(s), if any, to be taken based upon the predicted capacity provided by the capacity forecast component 120 and the predicted demand provided by the demand forecast component 140. In some embodiments, the predicted capacity and predicted demand are validated by a data quality validation component 168. The capacity mitigation engine component 160 can utilize one or more mitigation action logic components 170 with each mitigation action logic component 170 comprising business logic and/or rules. “Business logic” refers to operation(s) to determine which action(s) (e.g., mitigation action(s)), if any, to be taken (e.g., published) in response to certain predicted capacity and predicted demand. In some embodiments, business logic can be expressed in relative terms such as if demand is predicted to be one percent greater than predicted capacity, take these mitigation actions in a particular order or with a particular weight. In some embodiments, business logic can be expressed in absolute terms such as if predicted demand is greater than predicted capacity by X, take these mitigation actions in a particular order or with a particular weight.

A mitigation action logic component 170 can include conditional logic that expresses one or more condition(s) (e.g., simple and/or combined) which, if met, cause mitigation action(s) expressed in the business logic to be published. As discussed below, in some embodiments, a particular mitigation action logic component 170 can be dynamically modified (e.g., business logic and/or rules) based upon received feedback regarding a response of the computing system 110 to particular mitigation action(s) in view of particular received inputs. That is, the particular mitigation action logic component 170 (e.g., business logic and/or rules) can be adapted based upon the feedback.

In some embodiments, each mitigation action logic component 170 is applicable to a particular user, business, or resource need or issue. For example, mitigation action logic components 170 can be directed to customer/user centric conditions such as offer restriction(s), quota threshold, and/or demand shaping. Mitigation action logic components 170 can be directed to platform (computing system 110) centric conditions such a defragmentation, out for repair, and/or cluster buildout. A particular mitigation action logic component 170 can be directed to a single mitigation action and/or a plurality of mitigation actions to be taken.

In some embodiments, the mitigation action logic components 170 can be applied hierarchically with certain mitigation action logic component(s) 170 having precedence over other mitigation action logic component(s) 170. In some embodiments, the mitigation action logic components 170 are applied in parallel such that mitigation action(s) of the mitigation action logic components 170 whose conditional logic has been satisfied are published. In some embodiments, the mitigation action logic components 170 are applied in a sequential manner such that a mitigation action of a particular mitigation action logic component 170 is published first. After expiration of a threshold period of time to allow the computing system 110 to react and updated inputs to be received by the system 100, the capacity mitigation engine component 160 can determine whether any other mitigation action(s) are to be applied based upon the updated inputs.

In this manner, the capacity mitigation engine component 160 can employ a tiered approach in response to the predicted capacity provided by the capacity forecast component 120 and the predicted demands provided by the demand forecast component 140. For example, a first mitigation action component 170 can attempt to have additional resource(s) brought online. If the mitigation action(s) published by the first mitigation action component 170 do not yield the expected result(s) as reflected in updated inputs, a second mitigation action component 170 can attempt to have particular user(s) and/or particular job(s) blocked and/or given lower priority. Again, if the mitigation action(s) published by the second mitigation action component 170 do not yield the expected result(s) as reflected in updated inputs, one or more additional mitigation action components 170 can be invoked and their associated mitigation actions can be published, as needed.

In some embodiments, the capacity mitigation engine component 160 utilizes a dynamically configurable mitigation time horizon when determining which mitigation action(s) to apply and the duration of one or more of these mitigation action(s). By adjusting the mitigation time horizon, convergence time of the system 100 to steady state can be changed (e.g., increased and/or decreased), as desired. For example, for a particular computing system 110 with frequent changes (e.g., unreliable based upon resource(s) being frequently brought online and/or taken off line), a longer mitigation time horizon will allow the system 100 greater flexibility at arriving upon a convergence of the system 100.

The system 100 further includes one or more enforcement components 180 that take action (e.g., enforce) regarding the mitigation action(s) published by the capacity mitigation engine component 160. For example, the action can include taking the mitigation action(s) or requesting user approval before taking the mitigation action(s).

In some embodiments, the enforcement component 180 can affect/modify an offer restriction, a quota threshold, demand shaping, a defragmentation signal, resource(s) out for repair, and/or resource(s) to be built out. For example, the enforcement component 180 can provide rule(s) for pre-production validation, quota threshold pre-production value(s), defragmentation signal(s), out for repair order(s)/recommendation(s), and/or build out order(s)/recommendation(s).

In some embodiments, one or more mitigation action(s) are taken by the enforcement component 180 without user input. In some embodiments, one or more particular mitigation action(s) to be taken are first submitted for user approval. Only once the user has approved of the particular mitigation action(s) does the enforcement component 180 take the particular mitigation action(s). In this manner, an exception path can be created that allows mitigation action(s) to be overruled and/or modified by a user.

In some embodiments, the system 100 can self-tune by adaptively updating the capacity model 130, the demand model 150, and/or one or more mitigation action logic components 170 based on feedback regarding actual results produced in response to action(s) taken with respect to the forecast. In some embodiments, the inputs that are utilized by the capacity model 130 and/or the demand model 150 can be modified based upon the received feedback.

In some embodiments, the system 100 can surface and utilize efficiency metrics for individual mitigation action(s) using efficiency key performance indicator(s) 184. This can allow a user to determine effectiveness of particular mitigation action(s), thus allowing the user to modify the particular mitigation action(s), as necessary.

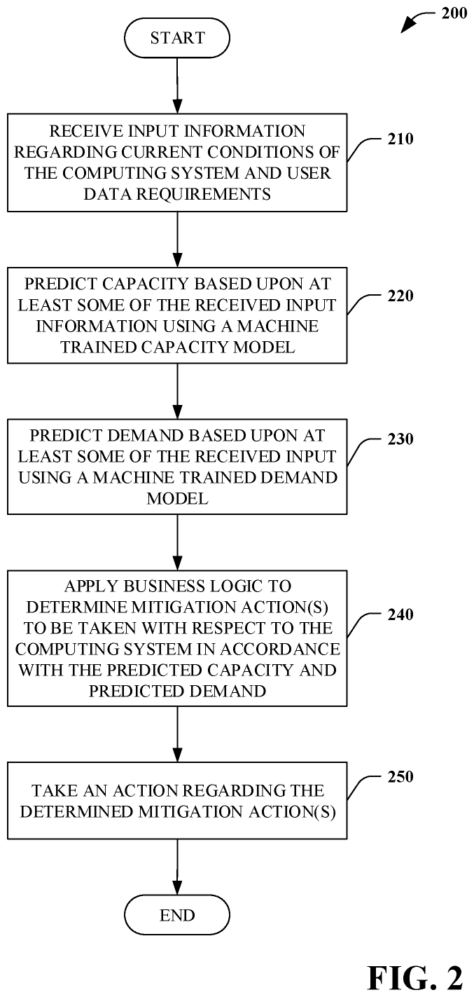

FIGS. 2-4 illustrate exemplary methodologies relating to automatically managing capacity of a computing system. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 2, a method of automatically managing capacity of a computing system 200 is illustrated. In some embodiments, the method 200 is performed by the system 100. At 210, input information regarding current conditions of the computing system, and, user data requirements are received.

At 220, capacity is predicted based upon at least some of the received input information using a machine trained capacity model capacity. At 230, demand is predicted based upon at least some of the received input using a machine trained demand model.

At 230, logic (e.g., business logic) is applied to determine one or more mitigation actions to be taken with respect to the computing system in accordance with the predicted capacity and predicted demand. At 240, an action is performed based upon the one or more determined mitigation actions. In some embodiments, the action performed includes applying the one or more determined mitigation actions.

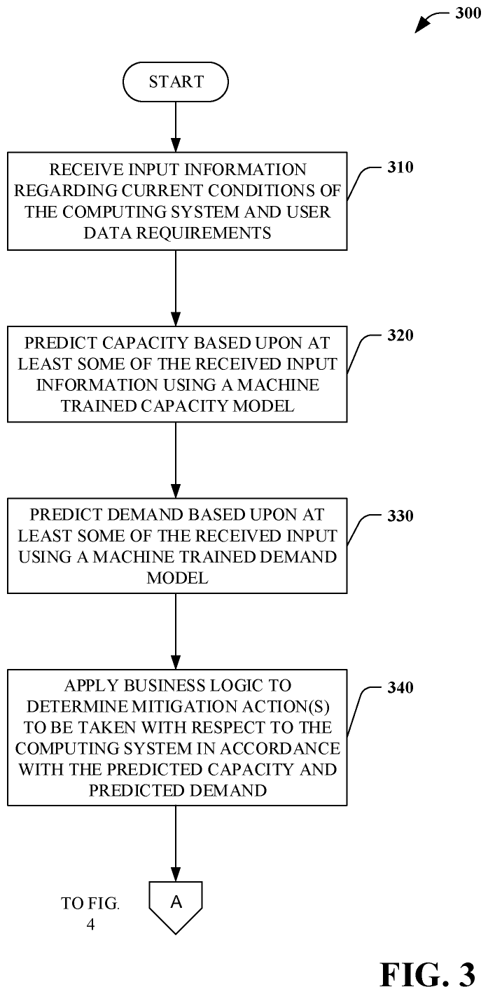

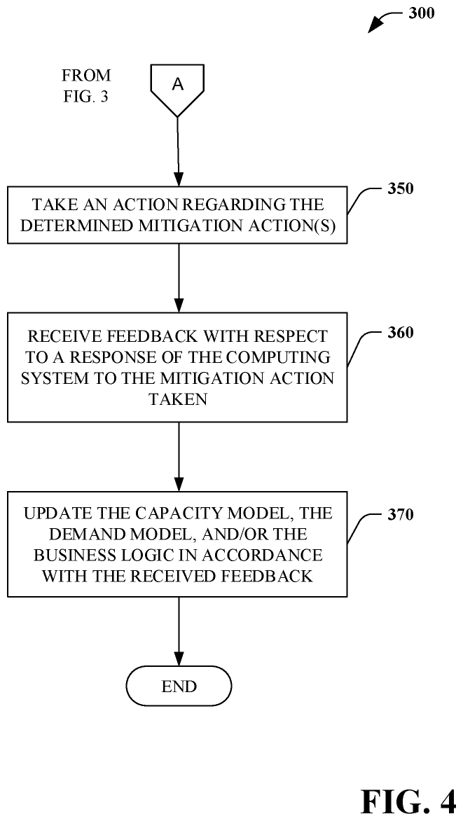

Turning to FIGS. 3 and 4, a method of automatically managing capacity of a computing system 300 is illustrated. In some embodiments, the method 300 is performed by the system 100.

At 320, capacity is predicted based upon at least some of the received input information using a machine trained capacity model capacity. At 330, demand is predicted based upon at least some of the received input using a machine trained demand model.

At 330, logic (e.g., business logic) is applied to determine one or more mitigation actions to be taken with respect to the computing system in accordance with the predicted capacity and predicted demand. At 340, an action is performed based upon the one or more determined mitigation actions (e.g., the one or more determined mitigation actions applied).

At 350, feedback with respect to a response of the computing system to the action taken is received. At 360, the capacity model, the demand model, and/or the logic is updated (e.g., adapted) in accordance with the received feedback.

Described herein is an automated capacity management system, comprising: a computer comprising a processor and a memory having computer-executable instructions stored thereupon which, when executed by the processor, cause the computer to: receive input information regarding current conditions of the computing system, and, user data requirements; predict capacity based upon at least some of the received input information using a machine trained capacity model; predict demand based upon at least some of the received input using a machine trained demand model; apply logic to determine one or more mitigation actions to be taken with respect to the computing system in accordance with the predicted capacity and predicted demand; and perform an action based upon the one or more determined mitigation actions.

The system can further include wherein the one or more determined mitigation actions comprises at least one of a rule for pre-production validation, an offer restriction, a quota threshold pre-production value, a defragmentation signal, an out for repair order/recommendation, or a cluster buildout order/recommendation.

The system can further include wherein the received input information further comprises an anticipated future condition of the computing system. The system can include the memory having further computer-executable instructions stored thereupon which, when executed by the processor, cause the computer to: receive feedback with respect to a response of the computing system to the action taken; and, update the capacity model in accordance with the received feedback. The system can include the memory having further computer-executable instructions stored thereupon which, when executed by the processor, cause the computer to: receive feedback with respect to a response of the computing system to the action taken; and, update demand model in accordance with the received feedback.

The system can include the memory having further computer-executable instructions stored thereupon which, when executed by the processor, cause the computer to: receive feedback with respect to a response of the computing system to the action taken; and, update the logic based upon received feedback.

The system can further include wherein at least one of the capacity model or the demand model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN) and/or a Gradient Boost & Adaboost algorithm.

The system can further include wherein the action performed comprises at least one of taking the one or more determined mitigation actions or requesting user approval before taking the one or more determined mitigation actions.

The system can include the memory having further computer-executable instructions stored thereupon which, when executed by the processor, cause the computer to: train the capacity model in an unsupervised manner; and train the demand model in an unsupervised manner. The system can further include wherein the computing system comprises a cluster computing system comprising a plurality of compute nodes.

Described herein is a method of automatically managing capacity of a computing system, comprising: receiving input information regarding current conditions of the computing system, and, user data requirements; predicting capacity based upon at least some of the received input information using a machine trained capacity model capacity; predicting demand based upon at least some of the received input using a machine trained demand model; applying logic to determine one or more mitigation actions to be taken with respect to the computing system in accordance with the predicted capacity and predicted demand; and performing an action based upon the one or more determined mitigation actions.

The method can further include wherein the one or more determined mitigation actions comprises at least one of a rule for pre-production validation, an offer restriction, a quota threshold pre-production value, a defragmentation signal, an out for repair order/recommendation, or a cluster buildout order/recommendation.

The method can further include wherein the received input information further comprises an anticipated future condition of the computing system. The method can further include receiving feedback with respect to a response of the computing system to the action taken; and, updating at least one of the capacity model, the demand model, or the logic in accordance with the received feedback.

The method can further include wherein the capacity model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN) and/or a Gradient Boost & Adaboost algorithm.

The method can further include wherein the demand model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN) and/or a Gradient Boost & Adaboost algorithm.

Described herein is a computer storage media storing computer-readable instructions that when executed cause a computing device to: receive input information regarding current conditions of the computing system, and, user data requirements; predict capacity based upon at least some of the received input information using a machine trained capacity model; predict demand based upon at least some of the received input using a machine trained demand model; apply logic to determine one or more mitigation actions to be taken with respect to the computing system in accordance with the predicted capacity and predicted demand; and perform an action based upon the one or more determined mitigation actions.

The computer storage media can further include wherein the one or more determined mitigation actions comprises at least one of a rule for pre-production validation, a quota threshold pre-production value, an offer restriction, a defragmentation signal, an out for repair order/recommendation, or a cluster buildout order/recommendation. The computer storage media can further include wherein the received input information further comprises an anticipated future condition of the computing system. The computer storage media can store further computer-readable instructions that when executed cause the computing device to: receive feedback with respect to a response of the computing system to the action taken; and, update at least one of the capacity model, the demand model, or the logic in accordance with the received feedback.

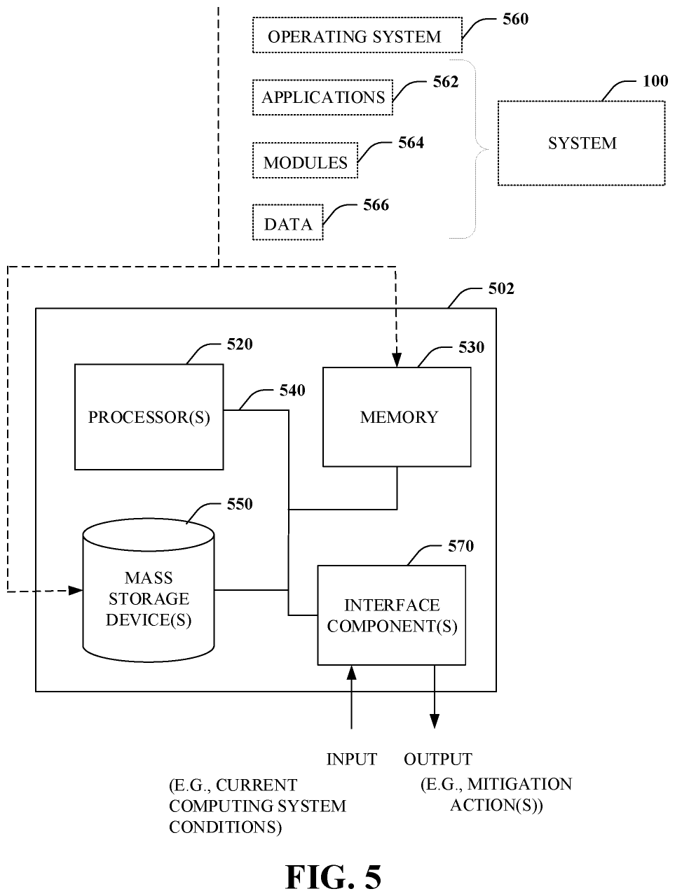

With reference to FIG. 5, illustrated is an example general-purpose computer or computing device 502 (e.g., mobile phone, desktop, laptop, tablet, watch, server, hand-held, programmable consumer or industrial electronics, set-top box, game system, and/or compute node). For instance, the computing device 502 may be used in an automated capacity management system 100.

The computer 502 includes one or more processor(s) 520, memory 530, system bus 540, mass storage device(s) 550, and one or more interface components 570. The system bus 540 communicatively couples at least the above system constituents. However, it is to be appreciated that in its simplest form the computer 502 can include one or more processors 520 coupled to memory 530 that execute various computer executable actions, instructions, and or components stored in memory 530. The instructions may be, for instance, instructions for implementing functionality described as being carried out by one or more components discussed above or instructions for implementing one or more of the methods described above.

The processor(s) 520 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 520 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 520 can be a graphics processor.

The computer 502 can include or otherwise interact with a variety of computer-readable media to facilitate control of the computer 502 to implement one or more aspects of the claimed subject matter. The computer-readable media can be any available media that can be accessed by the computer 502 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), and/or electrically erasable programmable read-only memory (EEPROM)), magnetic storage devices (e.g., hard disk, floppy disk, cassettes, and/or tape), optical disks (e.g., compact disk (CD), and/or digital versatile disk (DVD)), and solid state devices (e.g., solid state drive (SSD), flash memory drive (e.g., card, stick, and/or key drive), or any other like mediums that store, as opposed to transmit or communicate, the desired information accessible by the computer 502. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 530 and mass storage device(s) 550 are examples of computer-readable storage media. Depending on the exact configuration and type of computing device, memory 530 may be volatile (e.g., RAM), non-volatile (e.g., ROM, and/or flash memory) or some combination of the two. By way of example, the basic input/output system (BIOS), including basic routines to transfer information between elements within the computer 502, such as during start-up, can be stored in nonvolatile memory, while volatile memory can act as external cache memory to facilitate processing by the processor(s) 520, among other things.

Mass storage device(s) 550 includes removable/non-removable, volatile/non-volatile computer storage media for storage of large amounts of data relative to the memory 530. For example, mass storage device(s) 550 includes, but is not limited to, one or more devices such as a magnetic or optical disk drive, floppy disk drive, flash memory, solid-state drive, or memory stick.

Memory 530 and mass storage device(s) 550 can include, or have stored therein, operating system 560, one or more applications 562, one or more program modules 564, and data 566. The operating system 560 acts to control and allocate resources of the computer 502. Applications 562 include one or both of system and application software and can exploit management of resources by the operating system 560 through program modules 564 and data 566 stored in memory 530 and/or mass storage device (s) 550 to perform one or more actions. Accordingly, applications 562 can turn a general-purpose computer 502 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 562, and include one or more modules 564 and data 566 stored in memory and/or mass storage device(s) 550 whose functionality can be realized when executed by one or more processor(s) 520.

In accordance with one particular embodiment, the processor(s) 520 can correspond to a system on a chip (SOC) or like architecture including, or in other words integrating, both hardware and software on a single integrated circuit substrate. Here, the processor(s) 520 can include one or more processors as well as memory at least similar to processor(s) 520 and memory 530, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 502 also includes one or more interface components 570 that are communicatively coupled to the system bus 540 and facilitate interaction with the computer 502. By way of example, the interface component 570 can be a port (e.g. serial, parallel, PCMCIA, USB, and/or FireWire) or an interface card (e.g., sound, and/or video) or the like. In one example implementation, the interface component 570 can be embodied as a user input/output interface to enable a user to enter commands and information into the computer 502, for instance by way of one or more gestures or voice input, through one or more input devices (e.g., pointing device such as a mouse, trackball, stylus, touch pad, keyboard, microphone, joystick, game pad, satellite dish, scanner, camera, and/or other computer). In another example implementation, the interface component 570 can be embodied as an output peripheral interface to supply output to displays (e.g., LCD, LED, and/or plasma), speakers, printers, and/or other computers, among other things. Still further yet, the interface component 570 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. An automated capacity management system, comprising:
a computer comprising a processor and a memory having computer-executable instructions stored thereupon which, when executed by the processor, cause the computer to:
receive input information regarding current conditions of the computing system, and, user data requirements;
predict capacity based upon at least some of the received input information using a machine trained capacity model;
predict demand based upon at least some of the received input using a machine trained demand model;
apply logic to determine one or more mitigation actions to be taken with respect to the computing system in accordance with the predicted capacity and predicted demand; and
perform an action based upon the one or more determined mitigation actions.

2. The system of claim 1, wherein the one or more determined mitigation actions comprise at least one of a rule for pre-production validation, an offer restriction, a quota threshold pre-production value, a defragmentation signal, an out for repair order/recommendation, or a cluster buildout order/recommendation.

3. The system of claim 1, wherein the received input information further comprises an anticipated future condition of the computing system.

4. The system of claim 1, the memory having further computer-executable instructions stored thereupon which, when executed by the processor, cause the computer to:
receive feedback with respect to a response of the computing system to the action taken; and,
update the capacity model in accordance with the received feedback.

5. The system of claim 1, the memory having further computer-executable instructions stored thereupon which, when executed by the processor, cause the computer to:
receive feedback with respect to a response of the computing system to the action taken; and,
update the demand model in accordance with the received feedback.

6. The system of claim 1, the memory having further computer-executable instructions stored thereupon which, when executed by the processor, cause the computer to:
receive feedback with respect to a response of the computing system to the action taken; and,
update the logic based upon the received feedback.

7. The system of claim 1, wherein at least one of the capacity model or the demand model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN) and/or a Gradient Boost & Adaboost algorithm.

8. The system of claim 1, wherein the action performed comprises at least one of taking the one or more determined mitigation actions or requesting user approval before taking the one or more determined mitigation actions.

9. The system of claim 1, the memory having further computer-executable instructions stored thereupon which, when executed by the processor, cause the computer to:
train the capacity model in an unsupervised manner; and
train the demand model in an unsupervised manner.

10. The system of claim 1, wherein the computing system comprises a cluster computing system comprising a plurality of compute nodes.

11. A method of automatically managing capacity of a computing system, comprising:
receiving input information regarding current conditions of the computing system, and, user data requirements;
predicting capacity based upon at least some of the received input information using a machine trained capacity model;
predicting demand based upon at least some of the received input using a machine trained demand model;
applying logic to determine one or more mitigation actions to be taken with respect to the computing system in accordance with the predicted capacity and predicted demand; and
performing an action based upon the one or more determined mitigation actions.

12. The method of claim 11, wherein the one or more determined mitigation actions comprises at least one of a rule for pre-production validation, an offer restriction, a quota threshold pre-production value, a defragmentation signal, an out for repair order/recommendation, or a cluster buildout order/recommendation.

13. The method of claim 11, wherein the received input information further comprises an anticipated future condition of the computing system.

14. The method of claim 11, further comprising:
receiving feedback with respect to a response of the computing system to the action taken; and,
updating at least one of the capacity model, the demand model, or the logic in accordance with the received feedback.

15. The method of claim 11, wherein the capacity model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN) and/or a Gradient Boost & Adaboost algorithm.

16. The method of claim 11, wherein the demand model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN) and/or a Gradient Boost & Adaboost algorithm.

17. A computer storage media storing computer-readable instructions that when executed cause a computing device to:
receive input information regarding current conditions of the computing system, and, user data requirements;
predict capacity based upon at least some of the received input information using a machine trained capacity model;
predict demand based upon at least some of the received input using a machine trained demand model;
apply logic to determine one or more mitigation actions to be taken with respect to the computing system in accordance with the predicted capacity and predicted demand; and
perform an action based upon the one or more determined mitigation actions.

18. The computer storage media of claim 17, wherein the one or more determined mitigation actions comprise at least one of a rule for pre-production validation, a quota threshold pre-production value, an offer restriction, a defragmentation signal, an out for repair order/recommendation, or a cluster buildout order/recommendation.

19. The computer storage media of claim 17, wherein the received input information further comprises an anticipated future condition of the computing system.

20. The computer storage media of claim 17 storing further computer-readable instructions that when executed cause the computing device to:
receive feedback with respect to a response of the computing system to the action taken; and,
update at least one of the capacity model, the demand model, or the logic in accordance with the received feedback.
